(19) United States
(12) Patent Application Publication
(10) Pub. No.: US 2004/0127180 A1
(43) Pub. Date: Jul. 1, 2004

(54) Method and apparatus for detecting transmitted frequencies

(76) Inventors: Chris J. Burke, Capac, MI (US); Michael L. Rollwitz, Owatonna, MN (US); Garret Miller, Owatonna, MN (US); Robert Kochie, Mantorville, MN (US)

Correspondence Address: BAKER & HOSTETLER LLP, Washington Square, Suite 1100, 1050 Connecticut Avenue, N.W., WASHINGTON, DC, 20036, US

(21) Appl. No.: 10/329,772

(22) Filed: Dec. 27, 2002

(51) Int. Cl. H04B 1/18

(52) U.S. Cl. 455/161.3; 455/161.1

(57) ABSTRACT

A method and apparatus that includes a scanner for that scans a frequency range, a receiver that detects a frequency within the range, a processing unit for determining the field strength of the frequency and a display for indicating the field strength.

### FIELD OF THE INVENTION

The present invention relates generally to detecting data. More particularly, the present invention relates to identifying and detecting a range of radio frequencies and determining their relative field strength.

### BACKGROUND OF THE INVENTION

In the modern world, science and technology has allowed users or operators to control or operate machinery through the use of non-wired devices. These non-wires devices are able to interact with the machinery by transmitting commands and controls over light or radio waves.

The control device, at its most basic level, includes a transmitter and some type of processing unit. The operator would depress a button or select a command to be issued by the control device. The control device receives this command and processes and prepares them to be transmitted to the machinery. Once the commands are ready for transmitting, the commands are placed or incorporated into a carrier wave and transmitted to the machinery. The carrier wave can be radio frequency (RF), infrared light (IR), Bluetooth among many others.

The machinery is on the receiving end of this transmission. The machinery has a receiver to which it receives the transmission. The commands are stripped from the carrier wave and processed by the machinery. The commands instruct the machinery to perform the functions desired by the operator.

The use of wireless transmission has grown in popularity since its inception. Examples of where the wireless control devices are used are, cars, stereo system and telephones. The transmission of the frequency is usually only possible over short distances, which enables the devices to be secure from outsiders as well protecting the devices from noise, stray RF from TV towers, radio stations and the like.

Security of the machinery can be a problem especially when the device controls equipment that can be in the reach of nefarious individuals. For example, some automobiles can have a remote starter or keyless entry. The keyless entry enables the driver of the vehicle to unlock the car without the need to use a key to unlock the door. However, the keyless remote entry opens a security breach to which thieves are able to steal the car without having to break into the car. All that the thief has to do is determine the radio frequency and control commands. With this information, the thief is able to enter the car unimpeded. Prior art methods to overcome this problem have been authentication. For automobiles in particular, authentication, key fobs, is need to gain entry to a vehicle. The remote keyless entry contains an authentication key that is transmitted to the vehicle along with the commands. If the key matches, then the command is executed. If the key does not match, then the vehicle does not execute the commands from the control device.

Like all electro-mechanical devices, the remote control devices are subject to failure. However, when the mechanical device, linked to the remote device is not operating as instructed, it is difficult to determine the actual cause. There could be any number of causes that could affect the operation of the device. The operability of the remote control device is only one.

Since wireless transmission of data is invisible to the human eye, it has been difficult and time consuming for users of the device to determine the cause of a problem. Prior art methods to determine the remote control device have been time consuming. For example, many times the remote control device needs to be dismantled and each individual component checked. Some prior methods use a multimeter to check various voltages around various point to determine its operability. Even with this method, one is not able to tell with accuracy whether that the remote control device is operating properly or not. It is possible for the device to have all the correct voltage readings while the transmitter itself is malfunctioning.

Other methods of determining the operability of a remote control device is being able to detect the transmission of the carrier wave or wavelength. The problem with this method is the ability to detect a range of RF frequencies. For example, the frequency transmission can occur across a very broad range. Therefore, the operator of the remote control device would have to construct a device for that specific frequency. Having to know the specific frequency for detection purposes causes a number of problems. One is the ability of downstream purchasers to be able to determine the actual frequency at which the remote control device is transmitting. A number of manufacturers do not provide consumers with access to such information. This is especially true in instances in which security is an issue. Another problem is the ability to use a single device across a broad spectrum of wireless devices. If one needs to know the actual frequency of the wireless device, then the same detector cannot be used, for example, for garage door opener, tire pressure monitoring systems are also an excellent example and keyless remote entry. General auto mechanics are especially disadvantaged because each maker of automobiles generally uses a different carrier frequency. Therefore, the auto mechanic would have to buy a detector for each make of automobile they perform work.

All of these methods are time consuming, inefficient and expensive. Accordingly, it is desirable to provide a method and apparatus that enables a user to detect and determine the operability of a wireless control device.

It is also desirable to be able to detect the operability of a multitude of wireless control device despite their carrier frequency or modulation(AM/FM).

### SUMMARY OF THE INVENTION

One aspect of the present invention is to provide a device to detect frequencies across a broad range of transmitters.

In aspect of the present invention, an indication of the field strength is provided through such devices such as a visual display or an audio signal.

The above and other features and advantages are achieved through the use of a novel scanner that monitors a broad spectrum of frequencies as herein disclosed. In accordance with one embodiment of the present invention, an apparatus for detecting transmitted frequencies includes a broadband detector that scans a frequency range and a processing unit linked to the broadband detector to receive a signal detected by the broadband detector. In this embodiment, the frequency range is from 268 MHZ to 433 MHZ.

This embodiment further includes a field strength indicator, which can be a light emitting diode (LED) display or a field strength indicator, such as a liquid crystal display (LCD). The indicator can also be an audio field strength indicator that emits an audio sound such as a beep. The beep, in this embodiment, is activated when the field strength of the signal reaches a certain level.

Once the highest frequency within the band is detected, the detected signal is heterodyned and the processing unit converts it into a digital format. The conversion is accomplished with an analog to digital converter.

In an alternate embodiment of the present invention, a method for detecting frequencies across a spectrum range includes the steps of scanning a range of frequencies, detecting a frequency within this range and indicating the detection of the frequency, which is done in this embodiment with a display such as a light emitting diode (LED) or a liquid crystal display.

In another aspect of this embodiment, the present invention further includes the steps of receiving the detected frequency, converting the frequency into a digital format and determining its strength.

In another alternate embodiment, an apparatus for detecting frequencies across a spectrum range includes means for scanning a range of frequencies, means for detecting a frequency within this range and means for indicating the detection of the frequency. The means for indicating can be a visual display. Further elements can also include means for receiving the detected frequency linked to the means for scanning, means for converting the frequency into a digital format linked to the means for receiving and means for determining its strength linked to the means for converting.

In a further embodiment of the present invention, an apparatus that detects a frequency within a range includes a scanner that scans the range, a receiver linked to the scanner that detects a frequency within the range, a processing unit linked to the receiver that receives the frequency and determines a field strength and a field strength indicator that displays the field strength of the frequency.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a preferred embodiment of the present invention.

FIG. 2 is an illustration of a preferred embodiment of the present invention.

FIG. 3 is a flowchart illustrating the steps that may be followed in accordance with one embodiment of the present inventive method or process.

### DETAILED DESCRIPTION OF PREFERRED EMBODIMENTS OF THE INVENTION

A preferred embodiment of the present invention provides a method and apparatus for detecting a range of frequency transmissions to aid in determining whether a wireless control device is operating as intended.

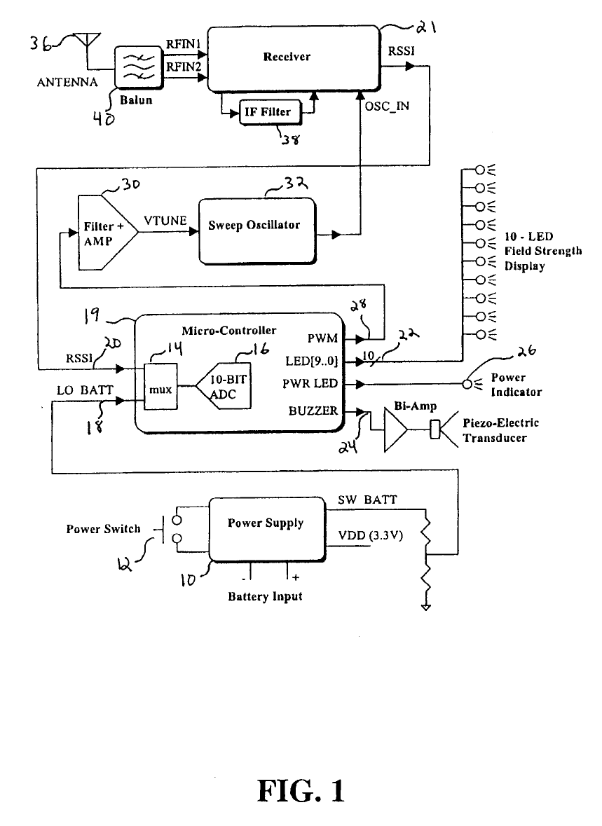

A preferred embodiment of the present inventive apparatus and method is illustrated in FIG. 1. The preferred embodiment of the present invention is a radio frequency (RF) detector designed to measure the signal strength or field strength of various remote control devices. The field strength is indicated to user.

The preferred embodiment operates as a spectrum analyzer. It sweeps a predetermined RF range and searches for signals in this range. In this embodiment, signals are detected on a logarithmic scale. A visual display such as an LED display measures and displays the change in the signal power level. The preferred embodiment can also activate an audio device in response to a pre-determined signal strength.

In FIG. 1, a power supply 10 is provided to power the unit. The unit is activated by a switch 12. The preferred embodiment incorporates the use of a nine volt power source. The circuitry can withstand twelve volts continuous and fifteen volts for two hundred and fifty milliseconds. The power supply 10 is linked to a micro-controller 12 or microprocessor. The micro-controller 12 includes a multiplexer 14, which is connected to a ten-bit analog to digital converter (ADC) 16.

The multiplexer 14 includes two inputs. The first input 18 is for low battery determination. The microcontroller 19 monitors the battery's state of voltage at start up or during the operation of the device. The second input 20 is the signal strength data received from the receiver 21. Either of the inputs 18, 20 are analog signals that are passed through a multiplexer 14 and through the ADC 16 from which the signals are analyzed by the micro-controller 12. The ADC 16 converts the inputs 18, 20 into digital format.

The inputs signals are analyzed by the microcontroller 12 from which an output is generated. The digital formatted signals are processed to determine the signal strength of the signal. This determination is then outputted to a light emitting diode (LED) display 22. The more LEDs that are activated directly corresponds to a higher field strength determination. The field strength determination can also trigger an audio activation output such as a buzzer. In the preferred embodiment, the present invention activates the buzzer 24 upon the reception of any frequency transmission strong enough to trigger the fifth LED or higher.

In alternate embodiment, the field strength indicators can be numerical, graphical or a textual display. The display can be indicated on any number of devices such as liquid crystal displays (LCD).

The micro-controller 12 also contains a power output 26 that indicates that sufficient power is being supplied to the micro-controller 12. The power output 26 is activated by analyzing the low battery input 18. If the voltage is sufficient to operate the microcontroller 19, then the power LED 26 is activated.

Another output from the micro-controller 19 is a digital output such as a pulse width modulator (PWM) 28 that generates the spectrum detection range. The PWM output, in the preferred embodiment, is a digital output that is then converted by an eight bit digital to analog converter (DAC). The output from the DAX is then fed into a combination of filter and amplifier 30. The filter and amplifier ensure that only those spectrum ranges are passed into the sweep oscillator 32. For example, if a user wants to detect frequency transmission between 100 MHZ and 200 MGZ, then the filter takes the output from the PWM 28 and eliminates or filters out the frequencies above and below the ranges. The filter range is amplified to enable the sweep oscillator 32 to operate efficiently. The value of the voltage start and stop points correspond to ranges, start and stop, of a frequency range. In the preferred embodiment, a memory device linked to the micro-controller 19 stores the range values. Alternate embodiments of the present invention include having a user reset the range of detection based on the user's need. An input device linked to the micro-controller 19 enables the user to alter the range of detection. The memory device is reprogrammed with the new spectrum range.

The preferred embodiment uses the invention to detect key fob, garage door openers and tire pressure detectors with a spectrum range of 268 MHZ to 434 MHZ. The spectrum range of detection can be also any possible range for which the receiver is capable of detecting. The present invention can be used to detect frequency transmission from key fobs, tire pressure detectors, wireless head sets, remote control devices for machinery and equipment such as television, radio, starters and any other type of device that can transmit data via a wireless frequency transmission.

The spectrum detection range is fed into the receiver 21. In the preferred embodiment, the receiver 21 is a heterodyne type with a zero intermediate frequency (IF). In other words, the receiver generates the frequency intended for reception using the sweep oscillator 32. This frequency is combined or heterodyned with a signal received at the antenna 36. The product of these two signals, the IF, is filtered to limit the bandwidth and to obtain selectivity. In the preferred embodiment, the IF frequency is passed through an IF filter 38 to maintain approximately a 2 MHZ selectively bandwidth. The amplitude of the IF frequency is representative of the amplitude of the signal at the antenna.

The antenna 36, in the preferred embodiment, is broadband and detects signals in all directions. The antenna is connected to an RF balun transformer 40. A balun is a device that joins a balanced line (one that has two conductors, with equal currents in opposite directions, such as a twisted pair cable) to an unbalanced line (one that has just one conductor and a ground, such as a coaxial cable). A balun is a type of transformer used to convert an unbalanced signal to a balanced one or vice versa. Baluns isolate a transmission line and provide a balanced output. A typical use for a balun is in a television antenna.

In a balun, one pair of terminals is balanced, that is, the currents are equal in magnitude and opposite in phase. The other pair of terminals is unbalanced: one side is connected to electrical ground and the other carries the signal. In the present invention, the balun transformer 40 serves to transform the antenna impedance to match the input of the receiver 34.

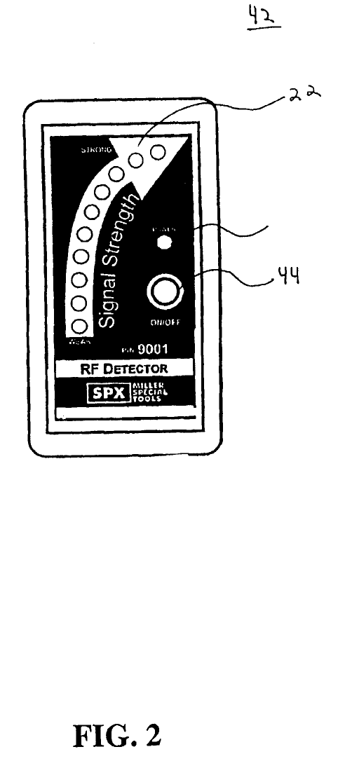

FIG. 2 is an illustration of front side of the preferred embodiment. The illustration is of a handheld device 42 that incorporates the present invention. The outside of the handheld device 42 contains a number of features. One of these is a power switch 44. By toggling the switch 44, power is supplied or not supplied to the micro-controller 19 and the rest of the internal components detailed in FIG. 1. To operate the device 42, a user depresses or toggles the power switch 44, which boots the micro-controller 19 and sets the spectrum range for the receiver to detect transmitted frequencies. A power LED provides a visual indicator that power switch has been toggled to an on position and that sufficient power exits to power the handheld device 42. The micro-controller 19 outputs a power output 26 that indicates that sufficient power is being supplied to the micro-controller 19. The power output 26 is activated by analyzing the low battery input 18. If the voltage is sufficient to operate the microcontroller 19, then the power LED 26 is activated.

The exterior of the handheld device also contains a visual field signal strength. The visual field signal strength indication or LED display 22 is an array of ten LEDs. In the preferred embodiment, the high number of LEDs activated indicates a stronger signal strength. The receiver 21 provides the second input 20 into the micro-controller 19. The amplitude of the IF, determined at the receiver 21, is a representative of the amplitude of the signal at the antenna. A logarithmic detector then outputs this representation to the micro-controller 19 at second input 18.

Not seen in FIG. 2 is the audio alert indicator or buzzer 24. The buzzer 24 is linked to the LED display 22 in that the buzzer 24 is activated when the LED display 22 is activated up until at least the fifth LED.

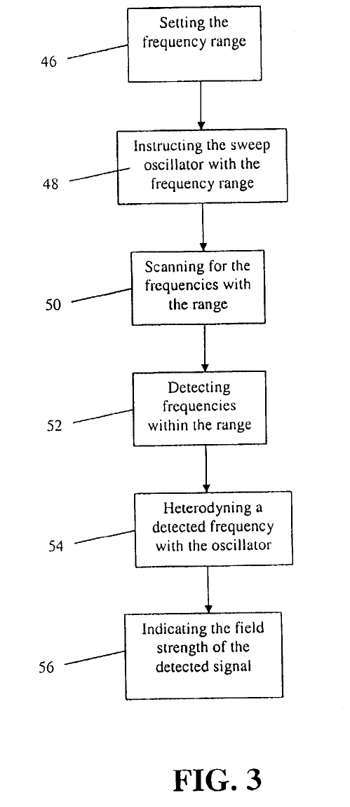

FIG. 3 is a flowchart illustrating the steps that may be followed in accordance with one embodiment of the present inventive method or process. The method is begun by the step 48 of setting a frequency spectrum for which the present invention scans. This range, through a step 50, is received by the sweep oscillator 32, which in turn initializes itself to scan the preset frequency range. For example, the preferred embodiment is used to detect key fobs or tire pressure. As a result, the frequency range is set between 268 MHZ and 434 MHZ. During a clock cycle, the invention then proceeds with the step 54 of detecting a frequency within the range selected. A detected frequency is received by the antenna 36 at the receiver 21, which completes the step 56 of heterodyning it with the signal from the sweep oscillator 32. The combination of the two frequencies creates the IF. The IF is then used by the present invention in the step 58 of indicating the signal strength of the detected signal. The preferred embodiment uses a filter the IF to maintain approximately a 2 MHZ selectivity bandwidth. The IF is further filtered to determine the amplitude of the signal at the antenna. Once determined, this data is then transmitted to the micro-controller 19.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for detecting transmitted frequencies comprising:
a broadband detector that scans a frequency range; and
a processing unit linked to the broadband detector to receive a signal detected by the broadband detector.

2. The apparatus as in claim 1, wherein the broadband measures signal strength of a transmitted frequency.

3. The apparatus as in claim 2, wherein the broadband detector detects radio frequencies in the range of 268 MHZ to 433 MHZ.

4. The apparatus as in claim 2, further comprising a field strength indicator.

5. The apparatus as in claim 4, wherein the field strength indicator is an light emitting diode (LED) display.

6. The apparatus as in claim 4, wherein the field strength indicator is a liquid crystal display (LCD).

7. The apparatus as in claim 1, further comprising an audio field strength indicator.

8. The apparatus as in claim 7, wherein the audio field strength indicator emits a beep.

9. The apparatus as in claim 1, wherein the processing unit converts the signal into a digital format.

10. The apparatus as in claim 9, wherein a analog to digital converter transforms the signal into the digital format.

11. The apparatus as in claim 5, wherein an audio field strength indicator is activated upon a certain strength level of the frequency.

12. The apparatus as in claim 11, wherein the audio strength indicator activates upon the LED display activating a fifth LED.

13. A method for detecting frequencies across a spectrum range comprising:
scanning a range of frequencies;
detecting a frequency within this range; and
indicating the detection of the frequency.

14. The method as in claim 13, wherein the step if indicating the detection of the frequency comprises a display.

15. The method as in claim 14, wherein the display is a light emitting diode (LED).

16. The method as in claim 14, wherein the display is a liquid crystal display.

17. The method as in claim 11, further comprising the step of receiving the detected frequency, converting the frequency into a digital format and determining its strength.

18. An system for detecting frequencies across a spectrum range comprising:
means for scanning a range of frequencies;
means for detecting a frequency within this range; and
means for indicating the detection of the frequency.

19. The system as in claim 18, wherein the means for indicating of the frequency comprises a display.

20. The system as in claim 19, wherein the display is a light emitting diode (LED).

21. The system as in claim 19, wherein the display is a liquid crystal display.

22. The system as in claim 11, further comprising means for receiving the detected frequency linked to the means for scanning, means for converting the frequency into a digital format linked to the means for receiving and means for determining its strength linked to the means for converting.

23. An apparatus that detects a frequency within a range comprising:
a scanner that scans the range;
a receiver linked to the scanner that detects a frequency within the range;
a processing unit linked to the receiver that receives the frequency and determines a field strength; and
a field strength indicator that displays the field strength of the frequency.
